(19) United States
(12) Patent Application Publication
(10) Pub. No.: US 2024/0186715 A1
(43) Pub. Date: Jun. 6, 2024

(54) RADIO WAVE REFLECTING APPARATUS AND MOBILE OBJECT

(71) Applicant: SONY GROUP CORPORATION, TOKYO (JP)

(72) Inventor: ATSUSHI YOSHIZAWA, TOKYO (JP)

(21) Appl. No.: 18/550,300

(22) PCT Filed: Jan. 18, 2022
(86) PCT No.: PCT/JP2022/001608

§ 371 Date: Sep. 13, 2023

(30) Foreign Application Priority Data
Mar. 22, 2021 (JP) 2021-047342

(51) Int. Cl. H01Q 15/18; B60Q 1/00; H01Q 15/14

(52) U.S. Cl. CPC H01Q 15/18; B60Q 1/0023; H01Q 15/141

(57) ABSTRACT

A radio wave reflecting apparatus according to one embodiment of the present technology includes a reflector array and a light source. The reflector array includes a plurality of unit corner reflectors each configured by joining a plurality of radio wave reflecting surfaces, the plurality of unit corner reflectors being disposed in an array. The light source is disposed at an edge portion of the unit corner reflector.

### TECHNICAL FIELD

The present technology relates to a radio wave reflecting apparatus that reflects a radar wave and to a mobile object.

### BACKGROUND ART

Patent Literature 1 describes a reflector that is mounted on a vehicle and reflects radar waves. This reflector is configured by three-dimensionally combining eight triangular pyramid-shaped corner reflectors and is housed in a spherical cover for use. For example, mounting the reflectors on respective units of a four-wheel vehicle or a two-wheel vehicle makes it possible to efficiently reflect radar waves transmitted from other vehicles or the like toward transmission sources

(paragraphs to of the specification, FIG. 2, and the like of Patent Literature 1).

### CITATION LIST

### Patent Literature

Patent Literature 1: Japanese Patent Application Laid-open No. 2016-75570

### DISCLOSURE OF INVENTION

### Technical Problem

Use of the reflector as described above makes it easy to detect vehicles and the like when a radar measurement is performed. Meanwhile, newly providing a reflector may lead to, for example, a possibility that a design according to an aesthetic appearance or aerodynamic performance of the vehicle is impaired. Hence, there is a demand for a technology capable of performing a stable radar measurement without impairing designability.

In view of the circumstances as described above, it is an object of the present technology to provide a radio wave reflecting apparatus and a mobile object that are capable of performing a stable radar measurement without impairing designability.

### Solution to Problem

In order to achieve the above object, a radio wave reflecting apparatus according to an embodiment of the present technology includes a reflector array and a light source.

The reflector array includes a plurality of unit corner reflectors each configured by joining a plurality of radio wave reflecting surfaces, the plurality of unit corner reflectors being disposed in an array.

The light source is disposed at an edge portion of the unit corner reflector.

In this radio wave reflecting apparatus, the reflector array is formed using the plurality of unit corner reflectors. Each unit corner reflector is configured by joining the plurality of radio wave reflecting surfaces, and the light source is disposed at the edge portion of the unit corner reflector. This makes it possible to use the radio wave reflecting apparatus as a light emitting apparatus capable of efficiently reflecting radar waves, and thus to perform a stable radar measurement without impairing designability.

The plurality of unit corner reflectors may be disposed in a close-packed manner.

The plurality of unit corner reflectors may be disposed in a planar shape.

The edge portion may include a portion to be a vertex and a side of a three-dimensional shape configured by the plurality of radio wave reflecting surfaces.

The plurality of radio wave reflecting surfaces may be three radio wave reflecting surfaces that are congruent isosceles right triangles. In this case, the unit corner reflector may have a shape configured by joining equal sides of the three radio wave reflecting surfaces with the radio wave reflecting surfaces facing inward.

The plurality of unit corner reflectors may be disposed such that openings each having an equilateral triangular shape constituted by bases of the three radio wave reflecting surfaces are disposed in a close-packed manner on a plane.

The light source may be disposed at a vertex of the opening of the equilateral triangular shape.

The reflector array may include a plurality of small reflectors that has a size-reduced shape of the unit corner reflector and is disposed at an outer edge portion of the plurality of unit corner reflectors.

The plurality of small reflectors may include a plurality of different types of small reflectors having different reduction ratios with respect to the unit corner reflectors.

The plurality of unit corner reflectors and the plurality of small reflectors may be disposed such that the respective openings are included in an identical plane.

The plurality of unit corner reflectors and the plurality of small reflectors may be disposed such that vertices facing the respective openings are included in an identical plane.

A size of the plurality of small reflectors may be set such that each opening thereof abuts on the adjacent unit corner reflector.

The light source may be a light-emitting diode (LED) light source.

The radio wave reflecting apparatus may be provided to a mobile object.

The mobile object may be a vehicle. In this case, the radio wave reflecting apparatus may be configured as at least one of a tail lamp, a brake lamp, a back lamp, or a blinker of the vehicle.

A mobile object according to an embodiment of the present technology includes a radio wave reflecting apparatus and a light emission controller.

The radio wave reflecting apparatus includes a reflector array including a plurality of unit corner reflectors each configured by joining a plurality of radio wave reflecting surfaces, the plurality of unit corner reflectors being disposed in an array, and a light source disposed at an edge portion of the unit corner reflector.

The light emission controller controls light emission of the light source.

### BRIEF DESCRIPTION OF DRAWINGS

FIG. 1 is a schematic view showing a configuration example of a radio wave reflecting apparatus according to the present technology.

FIG. 2 is a schematic view showing a configuration example of a unit corner reflector.

FIG. 3 is a schematic view showing a configuration example of a reflector array.

FIG. 4 is a schematic view showing an operation example of the radio wave reflecting apparatus.

FIG. 5 is a schematic view showing an application example of the radio wave reflecting apparatus.

FIG. 6 is a schematic view showing another configuration example of the radio wave reflecting apparatus.

FIG. 7 is a schematic view showing another configuration example of the radio wave reflecting apparatus.

FIG. 8 is a schematic view showing another configuration example of the radio wave reflecting apparatus.

FIG. 9 is a schematic view showing an example of a radio wave reflecting apparatus configured on a large scale.

FIG. 10 is a schematic view showing mount examples of the radio wave reflecting apparatus.

### MODE (S) FOR CARRYING OUT THE INVENTION

Hereinafter, embodiments according to the present technology will be described with reference to the drawings.

### Configuration of Radio Wave Reflecting Apparatus

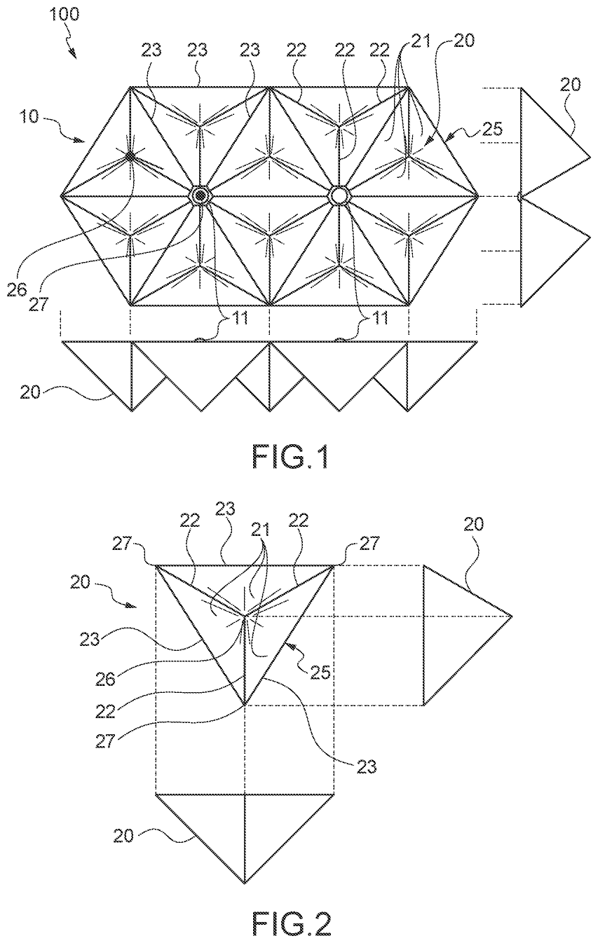

FIG. 1 is a schematic view showing a configuration example of a radio wave reflecting apparatus according to the present technology. FIG. 1 is a trihedral figure illustrating a plan view of a radio wave reflecting apparatus 100 as viewed from the front, a side view thereof as viewed from the lower side in the figure, and a side view thereof as viewed from the right side in the figure.

The radio wave reflecting apparatus 100 is an apparatus that reflects radio waves (radar waves) used in a radar measurement. For example, in FIG. 1, the side shown as a plan view (front side of radio wave reflecting apparatus 100) is the side on which radar waves are incident.

In this embodiment, the radio wave reflecting apparatus 100 is provided to a vehicle. For example, radar signals (radar waves) output from another vehicle or the like are reflected by the radio wave reflecting apparatus 100. In such a manner, the radio wave reflecting apparatus 100 functions as a radar signal reflecting apparatus.

As shown in FIG. 1, the radio wave reflecting apparatus 100 includes a reflector array 10 and light sources 11 disposed on the reflector array 10. The reflector array 10 is constituted using a plurality of unit corner reflectors 20, each of which is configured to be capable of reflecting radar waves.

Therefore, the radio wave reflecting apparatus 100 functions as a reflecting apparatus that reflects radar waves and also as a light source apparatus that causes the light sources 11 to emit light and then outputs the light.

The radio wave reflecting apparatus 100 is disposed, for example, at a rear part of the vehicle and is constituted as at least one of a tail lamp (tail light), a brake lamp (brake light), a back lamp (reversing light), or a blinker (directional indicator) of the vehicle. This makes it possible to efficiently reflect radar waves to another vehicle that performs a radar measurement of the vehicle equipped with the radio wave reflecting apparatus 100 from behind.

FIG. 2 is a schematic view showing a configuration example of the unit corner reflector 20. FIG. 2 shows a trihedral figure of the unit corner reflector 20.

The unit corner reflector 20 is constituted by joining a plurality of radio wave reflecting surfaces 21. The radio wave reflecting surface 21 is a plane capable of reflecting radio waves (radar waves). The radio waves incident on the radio wave reflecting surface 21 are reflected in a direction corresponding to the incident angle without passing through the radio wave reflecting surface 21.

The radio wave reflecting surface 21 is formed by, for example, performing vapor deposition of a metal film on a resin surface. Alternatively, the radio wave reflecting surface 21 may be formed by deforming and processing a metal member.

In this embodiment, three radio wave reflecting surfaces 21 each having a shape of a congruent isosceles right triangle are used as the plurality of radio wave reflecting surfaces. Hereinafter, sides of equal length constituting the isosceles right triangle will be referred to as equal sides 22, and the side between the equal sides 22 will be referred to as a base 23. The angle between the equal sides 22 (the angle of the vertex facing the base 23) is 90 degrees.

As shown in FIG. 2, the unit corner reflector 20 has a shape constituted by joining the equal sides 22 of the three radio wave reflecting surfaces 21 with the radio wave reflecting surfaces 21 facing inside. In other words, the unit corner reflector 20 has a recessed triangular pyramid shape formed by three-dimensionally joining the equal sides of the three isosceles triangles.

Further, in the unit corner reflector 20, an opening 25 having an equilateral triangular shape constituted by the bases 23 of the three radio wave reflecting surfaces 21 is formed.

For example, the plan view shown in FIG. 2 is viewed from the front of the opening 25 having an equilateral triangular shape, and a portion overlapping with the center of the opening 25 (an abutting portion of the right-angled vertices of the respective radio wave reflecting surfaces 21) is the vertex of the triangular pyramid recessed to the depth side of the plane of the drawing. This shape can also be, for example, a shape obtained by cutting out one corner of a cube such that the cross-section has an equilateral triangle.

Hereinafter, the vertex formed at the abutting portion of the right-angled vertices will be referred to as a main vertex 26, and the three vertices included in the opening 25 will be referred to as sub-vertices 27. Further, the axis passing through the center of the opening 25 and the main vertex 26 will be referred to as a center axis O of the unit corner reflector 20.

The size of the unit corner reflector 20 is set such that radar waves can be properly reflected. As will be described later, a millimeter-wave radar is typically used to detect vehicles or the like. In the unit corner reflector 20, for example, the length of the base 23 (length of one side of the opening 25) is set to be longer than the wavelength of radar waves (millimeter-waves) used in the millimeter-wave radar described above.

For example, in the millimeter waves of 77 GHz, the wavelength is approximately 3.9 mm. In this case, the length of the base 23 is set to be longer than the wavelength and also set in the range in which the size of the unit corner reflector 20 is prevented from increasing unnecessarily (e.g., approximately 10 mm to 20 mm).

Note that the size of the unit corner reflector 20 may be appropriately set, for example, in accordance with an assumed bandwidth of radar waves and such that those radar waves can be properly reflected. Example of the bandwidth of the millimeter-wave radar include the 24 GHz band, the 60 GHz band, the 76 GHz band, the 79 GHz band, the 94 GHz band, and the 140 GHz band. The unit corner reflector 20 may also be constituted in accordance with those bandwidths.

Additionally, the size of the unit corner reflector 20 is not limited and may be set to be compatible with any bandwidth.

The radar waves incident on the unit corner reflector 20 are sequentially reflected by the three radio wave reflecting surfaces 21, for example. As a result, the radar waves are reflected along a direction parallel to the incoming direction. In other words, the radar waves are reflected so as to return to the incoming direction.

Note that the incoming direction of the radar waves is not necessarily the front direction (direction parallel to the center axis O). For example, even if the radar waves come from a somewhat diagonal direction with respect to the center axis O, the radar waves are sequentially reflected by the three radio wave reflecting surfaces 21 of the unit corner reflector 20 to be directed to the original incoming direction (see FIG. 4 and the like). This makes it possible to stably and efficiently detect the reflected radar waves.

For example, in a corner reflector used in a radar test or the like, in which the base of the isosceles triangle has a length of 10 cm, a radar cross-section (RCS), which is an index of reflection performance, is approximately +14 dBsm to +15 dBsm in the millimeter-wave bandwidth of 77 GHz. Further, in general, the RCS of an automobile is approximately +10 dBsm, and the RCS of a human body is approximately 0 dBsm.

As described above, a metallic vehicle body is a favorable reflector, but as will be described later, it is not always capable of receiving stable reflection signals from the same reflection part in radar observation due to the complexity of the shape of the vehicle body. Therefore, it is conceivable that even if the RCS is relatively high, its value or distribution is not stable.

The unit corner reflector 20 is, for example, a downsized corner reflector of the above-mentioned corner reflector for the radar test, and exerts high reflection performance. In addition, as described above, the unit corner reflector 20 is capable of reflecting radar waves in the incoming direction thereof even if the position or posture of the unit corner reflector 20 is changed. In such a manner, if the unit corner reflector 20 is used, the incident radar waves can become stable, favorable reflection signals.

Therefore, for example, attaching the unit corner reflector 20 to a vehicle body makes it possible to enhance performance as a radar reflector of the vehicle body, that is, improve reflection characteristics of radar waves with respect to the vehicle.

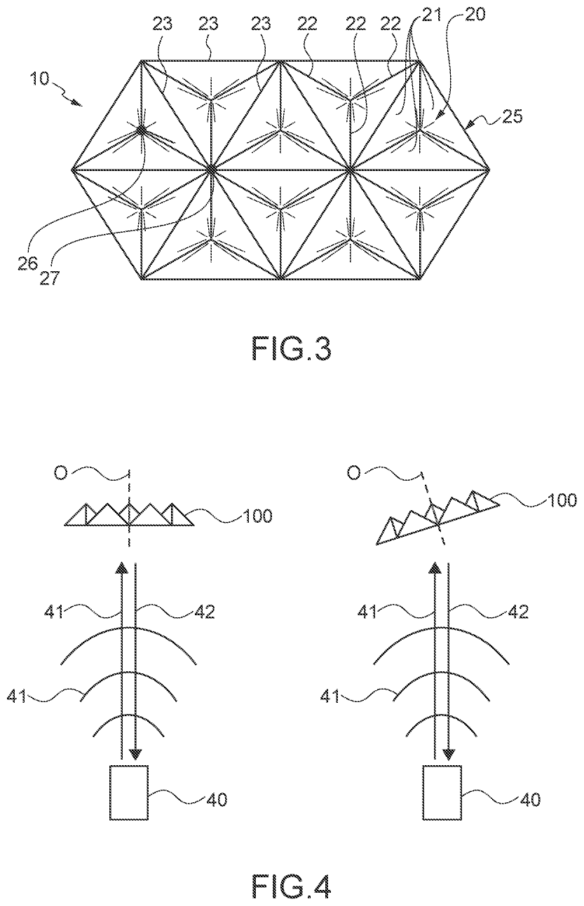

FIG. 3 is a schematic view showing a configuration example of the reflector array 10.

The reflector array 10 is constituted such that the plurality of unit corner reflectors 20 is disposed in an array. FIG. 3 is a plan view of the reflector array 10 viewed from the front.

In the reflector array 10, the plurality of unit corner reflectors 20 is disposed in a close-packed manner. In other words, in the reflector array 10, the unit corner reflectors 20 are disposed such that the density of the unit corner reflectors 20 is the highest. This makes it possible to maximize the number of unit corner reflectors 20 included in the reflector array 10.

Further, in the reflector array 10, the plurality of unit corner reflectors 20 is disposed in a planar shape. For example, the unit corner reflectors 20 each having the same shape are disposed along the plane. The reflector array 10 is thus planarized, which makes it possible to easily provide various two-dimensional shapes. Further, for example, it is possible to achieve substantially uniform reflection characteristics over the entire surface of the reflector array 10.

In this embodiment, as shown in FIG. 3, the plurality of unit corner reflectors 20 is disposed such that the openings 25, each of which has an equilateral triangular shape constituted by the bases 23 of the three radio wave reflecting surfaces 21, are disposed in a close-packed manner on the plane. For example, if equilateral triangles are disposed in a close-packed manner on the plane, the sides of the equilateral triangles are caused to abut on each other without shift. Repeating this achieves a close-packed arrangement as shown in FIG. 3.

In this case, a portion at which the unit corner reflectors 20 (openings 25 each having an equilateral triangular shape) are in contact with each other becomes a projected ridge line. Note that, in the unit corner reflector 20, a portion at which the radio wave reflecting surfaces 21 are in contact with each other becomes a recessed valley line. In the close-packed arrangement, a vertex (sub-vertex 27) of one opening 25 is connected with a maximum of six ridge lines and six valley lines.

In the example shown in FIG. 3, in the reflector array 10, five unit corner reflectors 20 are provided on each of the upper side and the lower side of the figure, and a plan view of the reflector array 10 has a hexagonal shape horizontally long as a whole. Further, in the radio wave reflecting apparatus 100 shown in FIG. 1, the reflector array 10 shown in FIG. 3 is used.

As described above, the reflector array 10 has a shape obtained by repeatedly arranging many unit corner reflectors 20, which are relatively small, in a planar shape, that is, a shape obtained by spreading the unit corner reflectors 20 over the plane.

Many unit corner reflectors 20 are arranged in parallel, so that the area capable of reflecting radar waves can be enlarged. For example, this makes it possible to cover the deterioration of reflection performance as a whole due to the downsizing of each unit corner reflector 20.

Further, since the depth of the unit corner reflector 20 is small, the depth of the reflector array 10 can be made small, for example, as compared with the case of using a single large corner reflector. In addition, since the unit corner reflector 20 is relatively small, it is possible to easily form a more complicated two-dimensional shape.

The reflector array 10 is formed of a resin, for example. In this case, for example, metal such as aluminum or copper is vapor-deposited on or attached to the surface of the resin formed in the shape shown in FIG. 3 and the like, thus forming the radio wave reflecting surfaces 21. This makes it possible to provide, for example, a lightweight and inexpensive radio wave reflecting apparatus 100.

Further, the reflector array 10 may be formed by processing a metallic member. In this case, for example, metal such as aluminum, steel, or copper is processed into the shape as shown in FIG. 3 by any processing method (press working, drilling processing, or the like). This makes it possible to provide, for example, a radio wave reflecting apparatus 100 having less deterioration or the like of the radio wave reflecting surfaces 21 and having high reliability.

Referring back to FIG. 1, the light source 11 is disposed at an edge portion of the unit corner reflector 20.

Here, the edge portion is, for example, a portion to be a side and a vertex of a three-dimensional shape, which is formed by the plurality of radio wave reflecting surfaces 21, in the unit corner reflector 20.

Here, the three radio wave reflecting surfaces 21 form a recessed triangular pyramid with the opening 25 having an equilateral triangular shape as a bottom surface. In the recessed triangular pyramid, a portion to be each vertex (sub-vertex 27) of the opening 25 or a vertex (main vertex 26) facing the opening 25 is included in the edge portion. Further, the base 23 (ridge line) connecting the sub-vertices 27 or the equal sides 22 (valley lines) connecting the sub-vertices 27 to the main vertex 26 are also included in the edge portion.

The light source 11 is disposed at any one of the edge portions described above. It also means that the light source 11 is disposed at a position other than the plane that reflects radar waves. This makes it possible to provide the light source 11 almost without reducing the reflection performance with respect to radar waves.

For the light source 11, typically, an LED light source is used. The LED light source has a small element size, and can thus be easily disposed at the edge portion described above. Further, use of the LED light source makes it possible to suppress power consumption or prolong the life of the apparatus.

Note that, in addition to the LED light source, another solid-state light source such as a laser diode (LD) may be used. Further, for example, a lamp light source or the like may be used.

As shown in FIG. 1, in this embodiment, the light source 11 is disposed at a vertex (sub-vertex 27) of the opening having an equilateral triangular shape. In other words, the LED light source is disposed at each position at which the bases 23 of the respective radio wave reflecting surfaces 21 intersect with each other in the unit corner reflectors 20 disposed in a close-packed manner. In the example shown in FIG. 1, the light source 11, which is disposed at a portion that is to be a sub-vertex 27 common to the six unit corner reflectors 20, is schematically illustrated. The light source 11 is disposed in such a manner, so that the deterioration of the performance as a corner reflector can be minimized.

Further, a relatively large space is easily ensured at a portion immediately below the sub-vertex 27. Hence, for example, wiring or a cooling mechanism of the light source 11 can be easily provided.

Further, if the size of the unit corner reflector 20 is suitably selected or a desired position is selected from the plurality of intersections (sub-vertices 27), an LED arrangement with a high degree of freedom becomes possible.

In addition, the position at which the light source 11 is disposed is not limited. For example, the light source 11 may be disposed at the deepest portion (main vertex 26) of the unit corner reflector 20. This makes it possible to, for example, diffuse the light output from the LED by using the radio wave reflecting surfaces 21. Further, the light source 11 may be disposed on the ridge line (base 23) or the valley line (equal side 22). This makes it possible to enhance the density of the light source 11 without reducing the reflection performance.

As described above, many unit corner reflectors 20, which are disposed in a close-packed manner and planarized, are disposed inside the radio wave reflecting apparatus 100. Further, in the close-packed pattern, the light sources 11 are disposed at portions, at each of which the rims (bases 23) of the respective unit corner reflectors 20 intersect with each other, for example. Thus, the radio wave reflecting apparatus 100 functions as a light source apparatus that efficiently reflects radar waves.

For example, there is a low probability that a tail lamp, a brake lamp, a back lamp, a blinker, and the like provided to a vehicle have a simple geometric shape, and it is conceivable that they basically have various shapes. In this embodiment, use of the reflector array 10 planarized with the unit corner reflector as a basic unit makes it possible to achieve a radio wave reflecting apparatus 100 that is matched with the shape of a lamp and also conformable to the frequency band of radar waves. Thus, excellent reflection performance with respect radar waves is exerted while a desired design is provided.

### Operation of Radio Wave Reflecting Apparatus

FIG. 4 is a schematic view showing an operation example of the radio wave reflecting apparatus 100. FIG. 4 schematically illustrates a state in which radar waves 41 applied from a radar apparatus 40 enter the radio wave reflecting apparatus 100 and are then reflected. The radar apparatus 40 detects the reflected radar waves 41 (reflected waves 42) to measure a position (distance), posture, shape, and the like of the radio wave reflecting apparatus 100 to be detected.

In (a) of FIG. 4, the radar waves 41 enter the radio wave reflecting apparatus 100 along a direction parallel to the center axis O of each unit corner reflector 20. In this case, the radar waves 41 are sequentially reflected by the radio wave reflecting surfaces 21 and eventually reflected along the incoming direction from which the radar waves 41 have come. As a result, the reflected waves 42 of the radar waves 41 return to the radar apparatus 40 and are then detected by a detection sensor (not shown).

Further, in (b) of FIG. 4, the radar waves 41 enter the radio wave reflecting apparatus 100 along a direction inclined with respect to the center axis O of each unit corner reflector 20. Even in such a case, because of the characteristics of the unit corner reflectors 20 described with reference to FIG. 2, the radar waves 41 are reflected along the incoming direction, and the reflected waves 42 are detected by the radar apparatus 40.

As described above, the radio wave reflecting apparatus 100 is capable of reflecting the radar waves 41 to return in the incoming direction of the radar waves 41 even when the posture with respect to the incoming direction of the radar waves 41 is changed. Hence, if a target (vehicle or the like) equipped with the radio wave reflecting apparatus 100 is measured by the radar apparatus 40, it is possible to stably detect the radar waves 41 (reflected waves 42) reflected by the radio wave reflecting apparatus 100.

In recent years, the technologies of sensing the periphery of a vehicle by using the radar apparatus 40 and of performing advanced drive control such as driving support of the vehicle have been developed. For the radar apparatus 40 mounted on the vehicle, typically, a millimeter-wave radar is used.

For example, an apparatus that is called LiDAR and senses the periphery by a laser beam is known. In general, the LiDAR is expensive and has a large casing in many cases. As compared with the LiDAR, the millimeter-wave radar is relatively inexpensive and small, and is widely spread. Further, the millimeter-wave radar using radio waves is less affected by back light, fog, or the like and has excellent resistance to climatic conditions, unlike the LiDAR that performs ranging by light. For those reasons, the millimeter-wave radar is practically used in the forms corresponding to various application uses from a long distance to a short distance, and is used for driving support of vehicles.

Meanwhile, in the measurement by the millimeter-wave radar, it is conceivable that “resolution performance”, which is a capability of distinguishing details of a target in a space, is generally lowered as compared with the measurement by the LiDAR. For example, in order to provide a millimeter-wave radar having high resolution performance, it is necessary to arrange antennas in an array and further enlarge the array to an extreme degree in the principle of the millimeter-wave radar. Therefore, in such a method, there is a risk that the characteristics of the millimeter-wave radar, such as being small and inexpensive, are impaired. Hence, regarding the millimeter-wave radar, there is a demand for a method of achieving higher resolution performance while maintaining the characteristics such as being small and inexpensive.

From the background as described above, sensing by a distributed radar using a plurality of small radars is attracting attention as one evolutionary axis of the millimeter-wave radar. In this method, a plurality of millimeter-wave radars is disposed dispersedly in the same vehicle, and a larger number of diverse reflected waves are received from a vehicle running ahead or the like. The received signals output by the radars dispersedly disposed are then integrated by back-end signal processing, so that the sensing performance is enhanced.

As described above, in the distributed radar, the individual radars are small and inexpensive, but diverse reflected waves are received by sensing from many locations, so that the diverse received signals can be acquired. Further, integrating information of the diverse reflected waves makes it possible to perform finer sensing such as efficiently estimating the outer shape of a vehicle running ahead.

However, the vehicle body of the vehicle to be sensed is not necessarily an object having reflection conditions suitable for a radar. For example, the shape of the vehicle body is not designed/manufactured with the intention of being subjected to sensing by a radar. In general, there is a high possibility that a vehicle body has an extremely complex shape as a reflector of electromagnetic waves. Hence, the direction of the reflection signals from the vehicle body is not expected to be an intended direction. For example, there is a high possibility that, in the rear part of the vehicle body, the reflected waves are scattered along the shape of a surface, for example, on a side surface or the like of a curved vehicle body. Hence, for example, even if the distributed radar is used, its utility may be limited.

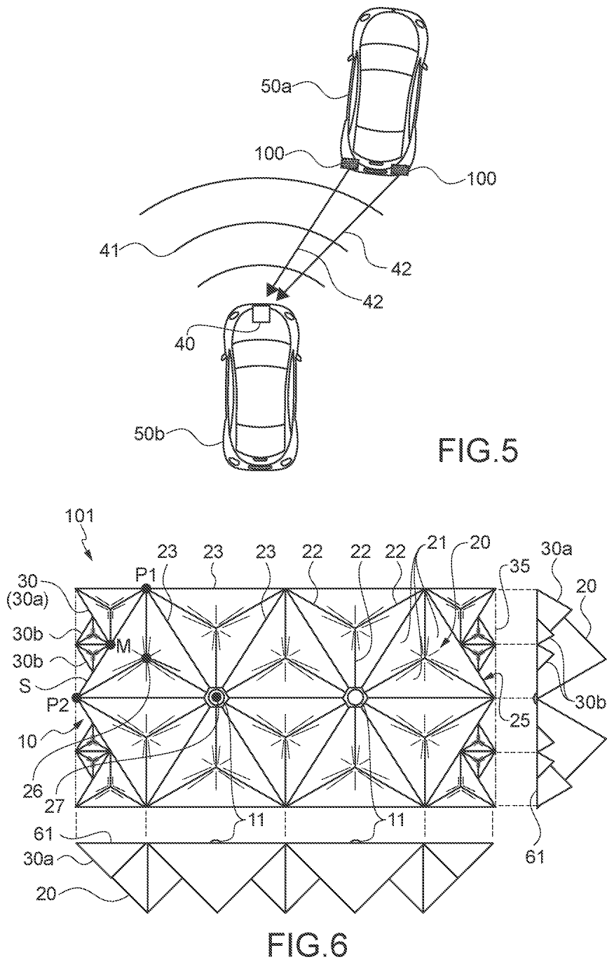

FIG. 5 is a schematic view showing an application example of the radio wave reflecting apparatus 100. FIG. 5 schematically illustrates a vehicle (vehicle 50a) equipped with the radio wave reflecting apparatus 100 and another vehicle (vehicle 50b) that performs measurement on the vehicle 50a from behind the vehicle 50a by the radar apparatus 40.

Two radio wave reflecting apparatuses 100 are provide to the rear part of the vehicle 50a. The radio wave reflecting apparatuses 100 are disposed on the left side and the right side of the vehicle 50a, for example, so as to constitute a tail lamp, a brake lamp, a back lamp, a blinker, and the like of the vehicle 50a.

Further, a light emission controller that controls light emission of the light source 11 of the radio wave reflecting apparatus 100 is provided to the vehicle 50a. Thus, ON/OFF or the like of the light emission is controlled depending on the operating situation of a driver who drives the vehicle 50a. In this embodiment, the vehicle 50a is an example of a mobile object that includes the radio wave reflecting apparatus.

For example, the radar waves 41 are applied forward from the radar apparatus 40 of the vehicle 50b. In the radio wave reflecting apparatus 100 on the left side of the vehicle 50a, the radar waves 41 are reflected, and the reflected waves 42 are output toward the radar apparatus 40. Similarly, the reflected waves 42 are output also from the radio wave reflecting apparatus 100 on the right side of the vehicle 50a toward the radar apparatus 40.

As described above, the incoming directions of the radar waves 41 as viewed from the radio wave reflecting apparatuses 100 on the right side and left side are directions different from each other, but in both of the radio wave reflecting apparatuses 100, the radar waves 41 are reflected to return, and then return to the radar apparatus 40 as the irradiation source.

Further, the measurement by the radar apparatus 40 is performed during movement of the vehicles 50a and 50b. Hence, a relative position or posture of the vehicle 50b (radio wave reflecting apparatus 100) with respect to the vehicle 50b (radar apparatus 40) constantly changes. Even in such a case, each radio wave reflecting apparatus 100 reflects the radar waves 41 to return. Hence, the radar apparatus 40 is capable of constantly stably receiving the reflected waves 42 from the right and left ends of the vehicle 50a.

As described above, the vehicle 50a is provided with the radio wave reflecting apparatuses 100, so that the vehicle 50a becomes a favorable reflector capable of stably reflecting the radar waves 41 regardless of its posture. In other words, the radio wave reflecting apparatus 100 is capable of improving the radar reflection characteristics of the vehicle 50a and providing stable reflection conditions with respect to the radar waves 41.

Further, it is also possible to enhance measurement accuracy in advanced sensing such as the distributed radar processing described above. For example, in the case of using the distributed radar, the radar waves 41 are applied from a plurality of millimeter-wave radars (radar apparatuses 40) dispersedly disposed in respective portions of the vehicle 50b. Even in such a case, the radio wave reflecting apparatus 100 reflects the radar waves 41, which have been applied from the millimeter-wave radars, to return to the respective irradiation sources. Thus, each millimeter-wave radar is capable of stably receiving the reflected waves 42 from the radio wave reflecting apparatus 100, which makes it possible to perform sensing with high accuracy.

For example, in the example shown in FIG. 5, since the radio wave reflecting apparatuses 100 are disposed on the right side and the left side of the vehicle 50a, it is possible to highly accurately sense information of a vehicle width of the vehicle 50a or information of a posture or the like of the vehicle 50a. Further, for example, even in a vehicle body with a complex design, the radar reflection characteristics can be satisfactorily improved if the radio wave reflecting apparatus 100 is provided.

Further, as described above, the radio wave reflecting apparatus 100 is configured as various light emitting apparatuses originally provided to the vehicle 50a. Hence, even if the radio wave reflecting apparatus 100 is provided, it apparently looks like a light emitting apparatus.

This makes it possible for the radio wave reflecting apparatus 100 to be naturally mounted on the vehicle body of the vehicle 50a as a part of the original equipment of the vehicle 50a. Further, an unnecessary protrusion or the like is not generated due to the radio wave reflecting apparatus 100 provided, and thus a design according to an aesthetic appearance or aerodynamic performance is not impaired.

By the way, for example, in accordance with security standards determined in each country (e.g., in Japan, security standards determined by the Road Transport Vehicle Act), a rear reflector is provided to a rear part of the vehicle. This is an instrument for efficiently reflecting light from a headlight of a vehicle running behind and is effective in notifying an approaching vehicle running behind of the presence of the own vehicle. In the security standards of the rear reflector, for example, the shape, material, attachment position, and the like of the rear reflector are determined for private vehicles, trucks, and the like.

As described above, in order to assist driving of the vehicle running behind, an instrument for effectively reflecting light from the headlight thereof is regulated by the laws. From this, it is conceivable that regulations regarding an efficient reflecting apparatus with respect to the millimeter-wave radar are added, from the viewpoint of assisting driving of a vehicle running behind, along with the diffusion of advanced sensing technologies such as automated driving or drive assist in the future.

In this embodiment, as described above, it is possible to provide the radio wave reflecting apparatus 100, as a part of the original equipment, to the vehicle 50a. Thus, for example, even if it is necessary to provide a reflecting apparatus for the millimeter-wave radar, the reflecting apparatus can be incorporated into a light emitting apparatus already provided, instead of newly providing a reflection tool or the like. Further, since a vehicle is provided with various light emitting apparatuses, a necessary radio wave reflecting apparatus 100 can be easily mounted using those apparatuses.

### Another Configuration of Radio Wave Reflecting Apparatus

FIG. 6 is a schematic view showing another configuration example of the radio wave reflecting apparatus.

In a radio wave reflecting apparatus 101 shown in FIG. 6, a reflector array 10 includes a plurality of small reflectors 30 in addition to the unit corner reflectors 20 described above. The reflector array 10 of the radio wave reflecting apparatus 101 has a configuration in which a plurality of small reflectors 30 is added to the reflector array 10 of the radio wave reflecting apparatus 100 described with reference to FIG. 1.

Each small reflector 30 has a shape reduced in size of the unit corner reflector 20. In other words, the small reflector 30 can also be a downsized unit corner reflector 20. Here, a small reflector 30 having a recessed triangular pyramid shape, which is reduced in size of the unit corner reflector 20 shown in FIG. 2, is used.

Hereinafter, the portions (side and vertex) of the small reflector 30 will also be denoted by reference symbols similar to those of the respective portions of the unit corner reflector 20.

Further, the plurality of small reflectors 30 is disposed at an outer edge portion 34 of the plurality of unit corner reflectors 20. Here, the outer edge portion 34 of the plurality of unit corner reflectors 20 is, for example, a portion to be the outer edge of a region formed when the plurality of unit corner reflectors 20 is arranged. For example, in a plan view, a portion at which the unit corner reflectors 20 are not in contact with each other is to be the outer edge portion 34.

As described above, the small reflectors 30 are disposed at the outer edge portion 34, and the reflectors having different sizes (unit corner reflectors 20 and small reflectors 30) are laid, which makes it possible to constitute a reflector array 10 having any planar shape.

As shown in FIG. 6, the plurality of small reflectors 30 includes a plurality of types of small reflectors 30 having different reduction ratios with respect to the unit corner reflectors 20. This makes it possible to fill gaps using the small reflectors 30 having different sizes. As a result, a portion in which reflectors are not provided, that is, a portion in which the radar waves 41 are not reflected, can be made small as much as possible. Note that the reduction ratio is appropriately set, for example, in the range in which the small reflectors 30 are capable of properly reflecting the radar waves 41.

Here, a small reflector 30a and a small reflector 30b are used, the small reflector 30a having a ½ length of the side (base 23) of the opening 25 with an equilateral triangular shape of the unit corner reflector 20, the small reflector 30b having a ¼ length of the base 23.

In the radio wave reflecting apparatus 101, the plurality of unit corner reflectors 20 and the plurality of small reflectors 30 are disposed such that the respective openings 25 are included in the same plane. Hereinafter, the surface on which the openings 25 of the respective unit corner reflectors 20 and small reflectors 30 are disposed will be referred to as a first surface 61. The first surface 61 is a plane on the front surface side of the reflector array 10.

In this case, the opening 25 of each reflector (unit corner reflector 20 and small reflector 30) is disposed along the first surface 61. Therefore, the reflector array 10 has a structure in which a plurality of triangular pyramid-shaped, recessed portions is provided along the first surface 61, and can be easily formed.

In the example shown in FIG. 6, ten unit corner reflectors 20 are disposed to form a region having a horizontally long hexagonal shape. In order that such a region having a hexagonal shape has a shape close to a rectangular designed region 35 (region indicated by the alternate long and short dash line in the figure), the ½- and ¼-sized small reflectors 30a and 30b are disposed. This can also be termination processing for changing both ends of the planarized unit corner reflectors 20 into any shape. Here, the small reflectors 30a and 30b smaller than the unit corner reflectors 20 fill the gaps in the designed region 35. Note that the designed region 35 is not limited to the rectangular shape and may be set to, for example, any shape such as a polygonal shape or a circular shape.

For example, the leftmost unit corner reflector 20 in the upper row in the figure will be described. In the opening 25 of such a unit corner reflector 20, the upper and lower vertices of a side S on the left side in the figure will be referred to as P1 and P2, respectively, and a midpoint between P1 and P2 will be referred to as M. On the side S, a ½-sized small reflector 30a is disposed on the P1 side such that one vertex thereof and the midpoint M coincide with each other. Further, on the side S, a ¼-sized small reflector 30a is disposed on the P2 side such that one vertex thereof and the midpoint M coincide with each other. Additionally, between the small reflectors 30a and 30b brought into contact with the side S, another ¼-sized small reflector 30b is disposed such that one vertex thereof and the midpoint M coincide with each other.

Similarly, also at the outer edge portion 34 adjacent to the unit corner reflectors 20 on the right side in the upper row, on the left side in the lower row, and on the right side in the lower row, one small reflector 30a and two small reflectors 30b are disposed so as to fill gaps in the designed region 35.

As described above, filling the gaps with the small reflectors 30 having a smaller size than the planarized unit corner reflectors 20 makes it possible to change the entire reflector array 10 into any shape and also enhance the reflection performance thereof.

Further, in the example shown in FIG. 6, the size of the small reflector 30 is sequentially scaled into ½ for downsizing. This makes it possible to provide a close-packed arrangement in the reflector array 10 as a whole including the small reflectors 30 provided at the outer edge portion 34. This makes it possible to satisfactorily enhance the reflection performance.

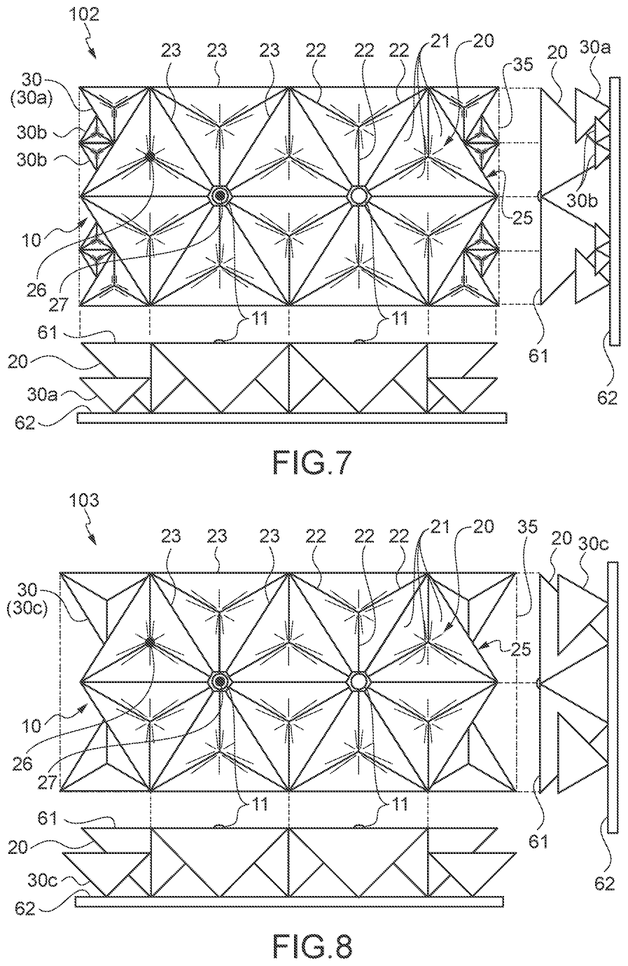

FIG. 7 is a schematic view showing another configuration example of the radio wave reflecting apparatus.

In a radio wave reflecting apparatus 102 shown in FIG. 7, a plurality of unit corner reflectors 20 and a plurality of small reflectors 30 are disposed such that vertices (main vertices 26) facing the respective openings 25 are included in the same plane. In other words, the small reflectors 30 that fill the gaps in a designed region 35 are disposed such that the main vertices 26 thereof are on the same plane as the main vertices 26 of the planarized unit corner reflectors 20.

Hereinafter, the surface on which the main vertices 26 of the respective unit corner reflectors 20 and small reflector 30 are disposed will be referred to as a second surface 62. The second surface 62 is a plane on the back surface side of the reflector array 10.

The radio wave reflecting apparatus 102 is configured such that the small reflectors 30 disposed at the outer edge portion 34 in the radio wave reflecting apparatus 101 shown in FIG. 6 are moved in parallel in a depth direction and the main vertices 26 of all the reflectors are located on the same plane (on the second surface). Therefore, the planar positions of the respective unit corner reflectors 20 and small reflectors 30 are similar to those of the radio wave reflecting apparatus 101, but as shown in the side view of FIG. 7, the positions of the respective small reflectors 30 in the depth direction are different from those of the radio wave reflecting apparatus 101.

As described above, the main vertices 26 of the respective reflectors (unit corner reflectors 20 and small reflectors 30) constituting the reflector array 10, that is, the positions thereof in the depth direction are aligned, so that the path length of the radar waves 41 is made uniform even when any reflector performs reflection. As a result, the phase of the reflected waves 42 from each reflector can be satisfactorily matched, and for example, the detection accuracy of the reflected waves 42 can be enhanced. This makes it possible to enhance the reflection accuracy of the entire reflector array 10 and achieve highly accurate sensing.

FIG. 8 is a schematic view showing another configuration example of the radio wave reflecting apparatus.

In a radio wave reflecting apparatus 103 shown in FIG. 8, reflectors (unit corner reflectors 20 and small reflectors 30) are disposed such that the main vertices 26 thereof are included in the same plane. In this state, the size of the small reflector 30 is set such that the small reflector 30 abuts on an adjacent unit corner reflector 20.

Specifically, the size of the plurality of small reflectors 30 is set such that the respective openings 25 thereof abut on adjacent unit corner reflectors 20. In other words, the size of the small reflector 30 disposed at the outer edge portion 34 is adjusted such that the small reflector 30 comes into contact with an adjacent unit corner reflector 20. In this case, the reduction ratio of the small reflector 30 slightly departs from the ½ scaling rule described with reference to FIG. 6 and the like.

In FIG. 8, four small reflectors 30c are provided so as to fill the gaps generated at the four corners of a rectangular designed region 35. The size of the small reflector 30c is set to, for example, the maximum size brought into contact with an adjacent unit corner reflector 20 in the range falling in the designed region 35.

Thus, the total area of the radio wave reflecting surfaces 21 of the small reflectors 30 increases, and the reflection performance can be improved. Further, since the degree of contact between the unit corner reflector 20 and the small reflector 30 increases, the entire mechanical strength can be enhanced.

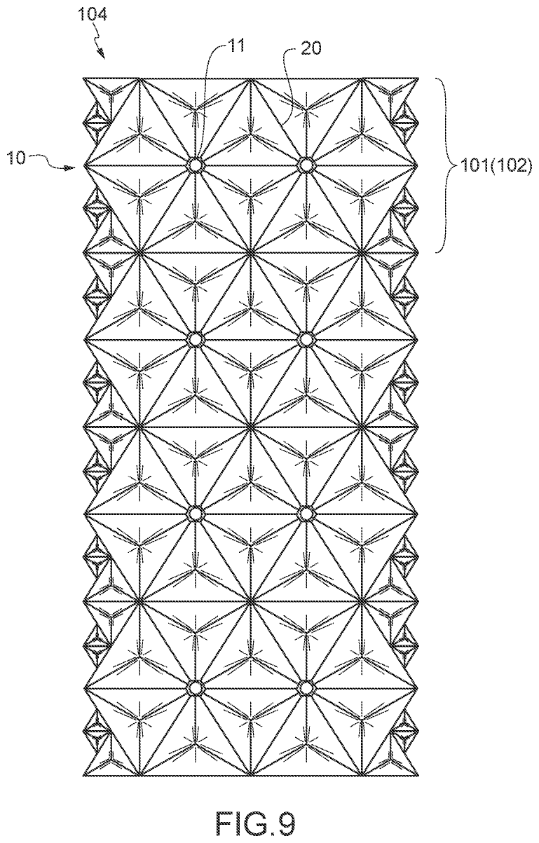

FIG. 9 is a schematic view showing an example of a radio wave reflecting apparatus configured on a large scale.

A radio wave reflecting apparatus 104 shown in FIG. 9 is, for example, an apparatus configured on a large scale by repeatedly arranging the radio wave reflecting apparatuses 101 shown in FIG. 6 (or the radio wave reflecting apparatuses 102 shown in FIG. 7). As a matter of course, the radio wave reflecting apparatus 100 or the radio wave reflecting apparatus 103 respectively shown in FIG. 1 or FIG. 8 can also be configured on a large scale.

In the radio wave reflecting apparatus 104, for example, with the radio wave reflecting apparatus 101 (or 102) as a unit pattern, four unit patterns are arranged such that the sides of respective patterns in the horizontal direction in the figure come into contact with each other. By such a method, for example, the radio wave reflecting apparatus 104 or the like that is long in one direction can be easily configured.

Note that two light sources 11 are provided to each unit pattern in the example shown in FIG. 9, but the present technology is not limited thereto. For example, the light source 11 may be disposed at a sub-vertex 27 or the like of the boundary between the unit patterns. This makes it possible to cause the radio wave reflecting apparatus 104 to emit light with a desired brightness.

Further, in the radio wave reflecting apparatus 104, it is also possible to enlarge the range of the apparatus (designed region 35) in the right and left directions in the figure. In this case, the number of unit corner reflectors 20 to be arranged in the horizontal direction only needs to be increased. In addition, the method of enlarging the range of the apparatus is not limited.

As described above, using the planarized unit corner reflectors 20 and the small reflectors 30 in combination and further repeatedly using those reflectors makes it possible to constitute a radio wave reflecting apparatus 104 having any area and shape along with the actual shape of a tail lamp, a brake lamp, a back lamp, a blinker, or the like.

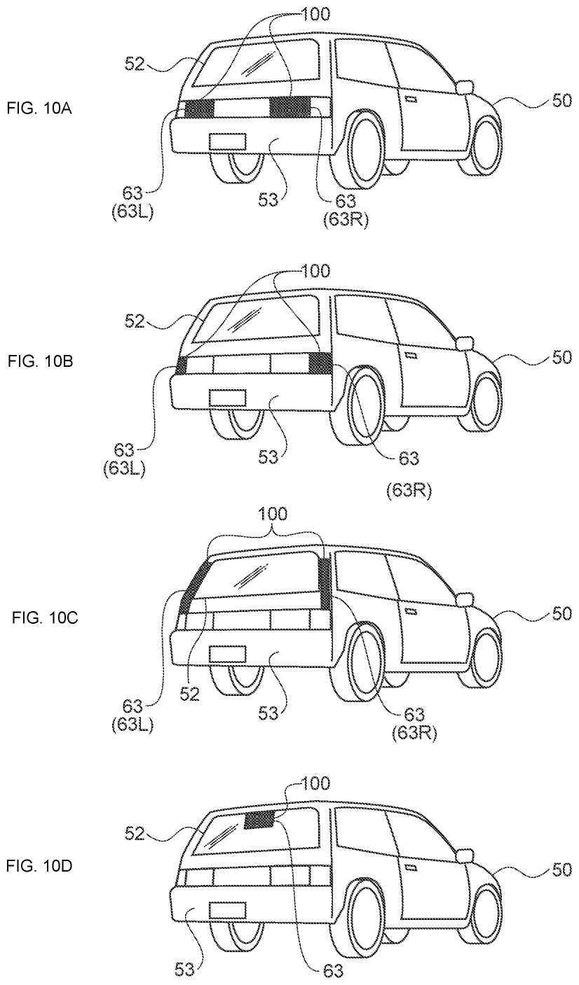

FIG. 10 is a schematic view showing mount examples of the radio wave reflecting apparatus.

Here, arrangement examples of cases where the radio wave reflecting apparatuses 100 to 104 are actually mounted on a vehicle 50 will be described.

A of FIG. 10 to D of FIG. 10 schematically illustrate lamp regions 63 in which the radio wave reflecting apparatus 100 or the like is provided in the rear part of the vehicle 50. Note that in FIG. 10, reference symbols are given using the radio wave reflecting apparatus 100 as an example, but as a matter of course, other configurations (radio wave reflecting apparatuses 101 to 104) and the like may be used.

In A of FIG. 10 to C of FIG. 10, the radio wave reflecting apparatuses 100 are provided in lamp regions 63L and 63R respectively disposed on the left and right in the rear part of the vehicle 50. In this case, the radio wave reflecting apparatuses 100 configured as, for example, a tail lamp, a brake lamp, a back lamp, or a blinker are provided in the lamp regions 63L and 63R.

In the example shown in A of FIG. 10, the lamp regions 63L and 63R are set at inward positions from the vehicle body side surfaces, between a rear window 52 and a rear bumper 53 of the vehicle 50. At that position, for example, a relatively large area can be ensured, so that the radio wave reflecting apparatus 100 can be enlarged. This makes it possible to detect a sufficient amount of reflected waves 42 by the radar apparatus 40 mounted on a vehicle running behind (see FIG. 5 and the like), and enhance the detection accuracy or the like of the vehicle 50.

In the example shown in B of FIG. 10, the lamp regions 63L and 63R are set near the vehicle body side surfaces, between the rear window 52 and the rear bumper 53 of the vehicle 50. In this case, the interval between the lamp regions 63L and 63R is nearly equal to the vehicle width. In this case, the reflected waves 42 reflected by the radio wave reflecting apparatus 100 become signals representing the vehicle width of the vehicle body. This makes it possible to accurately sense the outer shape, posture, and the like of the vehicle 50.

In the example shown in C of FIG. 10, vertically-long lamp regions 63L and 63R are set near the vehicle body side surfaces, along the rear window 52 of the vehicle 50. In such a region, the radio wave reflecting apparatus 100 large-scaled by, for example, the method as shown in FIG. 9 is provided. In this case as well, the interval between the lamp regions 63L and 63R is nearly equal to the vehicle width. The vertically-long reflectors are formed in the vehicle body side surfaces in such a manner, which makes it possible to satisfactorily accurately sense the outer shape, posture, and the like of the vehicle 50.

In the example shown in D of FIG. 10, a lamp region 63 is set near the upper center of the rear window 52 of the vehicle 50. In such a lamp region 63, for example, the radio wave reflecting apparatus 100 that functions as a tail lamp, a brake lamp, a back lamp, or the like is provided.

Providing the radio wave reflecting apparatus 100 at the center of the vehicle body makes it possible to accurately sense the center position or the like of the vehicle 50.

As described above, if the radio wave reflecting apparatus 100 is mounted, a portion at which a tail lamp, a brake lamp, a back lamp, a blinker, or the like is disposed functions as a favorable reflector. In other words, in observing the vehicle body rear part, such as both ends, of the vehicle body by the radar apparatus 40, the reflection performance of the portions forming the outer shape of the vehicle 50 is significantly enhanced. This makes it possible to stably perform advanced sensing.

Hereinafter, in the radio wave reflecting apparatus (100 to 104) according to this embodiment, the reflector array 10 is formed using the plurality of unit corner reflectors 20. Each unit corner reflector 20 is constituted by joining a plurality of radio wave reflecting surfaces 21, and the light source 11 is disposed at the edge portion thereof. Thus, the radio wave reflecting apparatus can be used as a light emitting apparatus capable of efficiently reflecting radar waves, which makes it possible to perform a stable radar measurement without impairing designability.

In general, the vehicle body is made of metal and is thus originally an object that gives a favorable reflection point with respect to the radar waves 41. However, in the design of the vehicle body, for example, the shape of the vehicle body is often determined from the aerodynamic or aesthetic viewpoints. Therefore, the shape of the vehicle body is not necessarily a shape providing the best reflection point with respect to the radar waves 41. Hence, for example, if the radar waves 41 are used to perform more advanced sensing such as obtaining detailed outer shape information of a vehicle, there is a possibility that necessary reflection information is not obtained.

For example, in the sensing for estimating an outer shape, information regarding both ends of a vehicle body is very important. Meanwhile, since an actual vehicle body often has a design using a curved surface or a complicated structure, there is a possibility that a reflection direction of the radar waves 41 is different from an incoming direction. This does not mean that a favorable reflection point is provided from the viewpoint of a reflector of the radar waves 41. For example, the reflected waves 42 (received signals), which are received by the radar apparatus 40 when a vehicle body having a complex shape is measured, are waves reflected at a portion accidentally satisfying reflection conditions among the applied radar waves 41, and are not waves whose reflection direction is intentionally controlled.

As the method of providing favorable reflection conditions to the radar waves 41, it is conceivable that an additional reflector is attached to the vehicle body surface as it is. However, in such a method, there is concern about impairing an aesthetic appearance of the vehicle and further deteriorating aerodynamic performance.

In this embodiment, the radio wave reflecting apparatus is provided with the reflector array 10 including the plurality of unit corner reflectors 20. Further, the light source 11 is provided at an edge portion of each unit corner reflector 20. Therefore, the radio wave reflecting apparatus also functions as a light source apparatus that properly reflects the radar waves 41 and causes the light source 11 to emit light, thus outputting light.

This makes it possible for the radio wave reflecting apparatus to be naturally incorporated into the vehicle to serve as a light source apparatus such as a tail lamp, a brake lamp, a back lamp, or a blinker.

For example, in a vehicle that mounts the radio wave reflecting apparatus at a rear part thereof, reflection conditions can be controlled regardless of the shape of the rear part of the vehicle body or the like. This makes it possible to greatly enhance, for example, reflection performance or the like on the vehicle body side surface. Further, it is also possible to provide stable reflected waves 42 to the radar apparatus 40 that measures a vehicle from behind, or the like. This makes it possible to satisfactorily enhance the performance on outer shape sensing by the radar waves 41.

Further, the radio wave reflecting apparatus is mounted on a vehicle to serve as a light source apparatus (brake lamp, a back lamp, a blinker, etc.) originally provided to the vehicle. This makes it possible to minimize the impact on an aerodynamic or aesthetic design and to avoid a situation in which designability is impaired.

As described above, an apparatus having both a reflecting function with respect to radar waves and a light emitting function is integrated into, for example, the inside of the cover or the like, so that it is possible to facilitate attachment or reduce aged deterioration. Further, the apparatus can be mounted in the form additionally provided at a portion to be originally used (light source apparatus), which makes it possible to avoid, for example, a situation in which the current design or the like is changed non-randomly.

### Other Embodiments

The present technology is not limited to the embodiment described above and can implement various other embodiments.

In the above embodiment, the example in which the openings 25 having an equilateral triangular shape of the respective unit corner reflectors 20 are disposed in a close-packed manner in the reflector array 10 has been described. The method of arranging the unit corner reflectors 20 is not limited to this method.

For example, the sides (bases 23) of the respective openings 25 may be disposed at predetermined intervals therebetween.

Further, for example, in the reflector array 10 shown in FIG. 3, the unit corner reflectors 20 may be partially removed. For example, a pattern in which only unit corner reflectors 20 disposed with the vertex of the opening 25 facing upward in the figure (or downward in the figure) remain may be used. In addition, a pattern excluding any unit corner reflector 20 may be used.

Further, in the reflector array 10, the positions of the respective openings 25 may be shifted. For example, a pattern in which five unit corner reflectors 20 on the upper row in the figure and five unit corner reflectors 20 on the lower row in the figure are shifted may be used. This is a pattern in which the unit corner reflectors 20 on the upper and lower rows are shifted in the horizontal direction in the figure. Alternatively, a pattern in which the unit corner reflectors 20 are shifted along a diagonal direction in the figure may be used.

In the above embodiment, the configuration of each unit corner reflector 20 in which the opening 25 has an equilateral triangular shape has been described. The present technology is not limited to the above, and the shape of the opening 25 of each unit corner reflector 20 may be set discretionally.

For example, a configuration in which the shape of the opening 25 is a regular hexagonal shape as viewed along the center axis O is also possible. In this case, the unit corner reflector 20 has a shape obtained by cutting off the three vertices (sub-vertices 27) of the above-mentioned opening 25 having an equilateral triangular shape to have a regular hexagonal shape as viewed from the front. Even in such a case, the unit corner reflectors 20 can be disposed in a close-packed manner. This makes it possible to achieve designs rich in variations.

Further, in the reflector array 10, each unit corner reflector 20 is not necessarily disposed in a planar shape. For example, in the reflector array 10 shown in FIG. 3, the shape in which the reflector array 10 is folded along the boundary line between the upper and lower rows in the figure may be used. In this case, the reflector array 10 may be folded to have a projected shape such that the openings 25 face outward or to have a recessed shape such that the openings 25 face inward.

The reflector array 10 is three-dimensionally configured in such a manner, so that the shape or the like corresponding to the design of the vehicle body can be achieved, for example.

In the above embodiment, the case where the present technology is mainly mounted on a vehicle (automobile) has been described as an example of a mobile object. The present technology is applicable to any other mobile objects such as motorcycles, ships, airplanes, bicycles, robots, and drones in addition to automobiles.

At least two of the characteristic portions according to the present technology described above can also be combined. In other words, the various characteristic portions described in each embodiment may be discretionally combined without distinguishing between the embodiments. Further, the various effects described above are not limitative but are merely illustrative, and other effects may be provided.

In the present disclosure, “same”, “equal”, “orthogonal”, and the like are concepts including “substantially the same”, “substantially equal”, “substantially orthogonal”, and the like. For example, the states included in a predetermined range (e.g., range of +10%) with reference to “completely the same”, “completely equal”, “completely orthogonal”, and the like are also included.

Note that the present technology can also have the following configurations.

(1) A radio wave reflecting apparatus, including:
a reflector array including a plurality of unit corner reflectors each configured by joining a plurality of radio wave reflecting surfaces, the plurality of unit corner reflectors being disposed in an array; and
a light source disposed at an edge portion of the unit corner reflector.
   (2) The radio wave reflecting apparatus according to (1), in which
the plurality of unit corner reflectors is disposed in a close-packed manner.
   (3) The radio wave reflecting apparatus according to (1) or (2), in which
the plurality of unit corner reflectors is disposed in a planar shape.
   (4) The radio wave reflecting apparatus according to any one of (1) to (3), in which
the edge portion includes a portion to be a vertex and a side of a three-dimensional shape configured by the plurality of radio wave reflecting surfaces.
   (5) The radio wave reflecting apparatus according to any one of (1) to (4), in which
the plurality of radio wave reflecting surfaces are three radio wave reflecting surfaces that are congruent isosceles right triangles, and
the unit corner reflector has a shape configured by joining equal sides of the three radio wave reflecting surfaces with the radio wave reflecting surfaces facing inward.
   (6) The radio wave reflecting apparatus according to (5), in which
the plurality of unit corner reflectors is disposed such that openings each having an equilateral triangular shape constituted by bases of the three radio wave reflecting surfaces are disposed in a close-packed manner on a plane.
   (7) The radio wave reflecting apparatus according to (6), in which
the light source is disposed at a vertex of the opening of the equilateral triangular shape.
   (8) The radio wave reflecting apparatus according to (6) or (7), in which
the reflector array includes a plurality of small reflectors that has a size-reduced shape of the unit corner reflector and is disposed at an outer edge portion of the plurality of unit corner reflectors.
   (9) The radio wave reflecting apparatus according to (8), in which
the plurality of small reflectors includes a plurality of different types of small reflectors having different reduction ratios with respect to the unit corner reflectors.
   (10) The radio wave reflecting apparatus according to (8) or (9), in which
the plurality of unit corner reflectors and the plurality of small reflectors are disposed such that the respective openings are included in an identical plane.
   (11) The radio wave reflecting apparatus according to (8) or (9), in which
the plurality of unit corner reflectors and the plurality of small reflectors are disposed such that vertices facing the respective openings are included in an identical plane.
   (12) The radio wave reflecting apparatus according to (11), in which
a size of the plurality of small reflectors is set such that each opening thereof abuts on the adjacent unit corner reflector.
   (13) The radio wave reflecting apparatus according to any one of (1) to (12), in which
the light source is a light-emitting diode (LED) light source.
   (14) The radio wave reflecting apparatus according to any one of (1) to (13), in which
the radio wave reflecting apparatus is provided to a mobile object.
   (15) The radio wave reflecting apparatus according to (14), in which
the mobile object is a vehicle, and
the radio wave reflecting apparatus is configured as at least one of a tail lamp, a brake lamp, a back lamp, or a blinker of the vehicle.
   (16) A mobile object, including:
a radio wave reflecting apparatus including
   a reflector array including a plurality of unit corner reflectors each configured by joining a plurality of radio wave reflecting surfaces, the plurality of unit corner reflectors being disposed in an array, and
   a light source disposed at an edge portion of the unit corner reflector; and
a light emission controller that controls light emission of the light source.

### REFERENCE SIGNS LIST

10 reflector array
11 light source
20 unit corner reflector
21 radio wave reflecting surface
22 equal side
23 base
25 opening
26 main vertex
27 sub-vertex
30, 30a, 30b, 30c small reflector
34 outer edge portion
35 designed region
41 radar wave
42 reflected wave
50, 50a, 50b vehicle
100, 101, 102, 103, 104 radio wave reflecting apparatus

1. A radio wave reflecting apparatus, comprising:
a reflector array including a plurality of unit corner reflectors each configured by joining a plurality of radio wave reflecting surfaces, the plurality of unit corner reflectors being disposed in an array; and
a light source disposed at an edge portion of the unit corner reflector.

2. The radio wave reflecting apparatus according to claim 1, wherein
the plurality of unit corner reflectors is disposed in a close-packed manner.

3. The radio wave reflecting apparatus according to claim 1, wherein
the plurality of unit corner reflectors is disposed in a planar shape.

4. The radio wave reflecting apparatus according to claim 1, wherein
the edge portion includes a portion to be a vertex and a side of a three-dimensional shape configured by the plurality of radio wave reflecting surfaces.

5. The radio wave reflecting apparatus according to claim 1, wherein
the plurality of radio wave reflecting surfaces are three radio wave reflecting surfaces that are congruent isosceles right triangles, and
the unit corner reflector has a shape configured by joining equal sides of the three radio wave reflecting surfaces with the radio wave reflecting surfaces facing inward.

6. The radio wave reflecting apparatus according to claim 5, wherein
the plurality of unit corner reflectors is disposed such that openings each having an equilateral triangular shape constituted by bases of the three radio wave reflecting surfaces are disposed in a close-packed manner on a plane.

7. The radio wave reflecting apparatus according to claim 6, wherein
the light source is disposed at a vertex of the opening of the equilateral triangular shape.

8. The radio wave reflecting apparatus according to claim 6, wherein
the reflector array includes a plurality of small reflectors that has a size-reduced shape of the unit corner reflector and is disposed at an outer edge portion of the plurality of unit corner reflectors.

9. The radio wave reflecting apparatus according to claim 8, wherein
the plurality of small reflectors includes a plurality of different types of small reflectors having different reduction ratios with respect to the unit corner reflectors.

10. The radio wave reflecting apparatus according to claim 8, wherein
the plurality of unit corner reflectors and the plurality of small reflectors are disposed such that the respective openings are included in an identical plane.

11. The radio wave reflecting apparatus according to claim 8, wherein
the plurality of unit corner reflectors and the plurality of small reflectors are disposed such that vertices facing the respective openings are included in an identical plane.

12. The radio wave reflecting apparatus according to claim 11, wherein
a size of the plurality of small reflectors is set such that each opening thereof abuts on the adjacent unit corner reflector.

13. The radio wave reflecting apparatus according to claim 1, wherein
the light source is a light-emitting diode (LED) light source.

14. The radio wave reflecting apparatus according to claim 1, wherein
the radio wave reflecting apparatus is provided to a mobile object.

15. The radio wave reflecting apparatus according to claim 14, wherein
the mobile object is a vehicle, and
the radio wave reflecting apparatus is configured as at least one of a tail lamp, a brake lamp, a back lamp, or a blinker of the vehicle.

16. A mobile object, comprising:
a radio wave reflecting apparatus including
a reflector array including a plurality of unit corner reflectors each configured by joining a plurality of radio wave reflecting surfaces, the plurality of unit corner reflectors being disposed in an array, and
a light source disposed at an edge portion of the unit corner reflector; and
a light emission controller that controls light emission of the light source.
